(19) United States
(12) Patent Application Publication
(10) Pub. No.: US 2026/0312890 A1
(43) Pub. Date: Oct. 8, 2026

(54) COMMON MEDIA CLIENT DATA REPORTING AND CONFIGURATION FOR A 5G MEDIA STREAMING CLIENT

(71) Applicant: InterDigital VC Holdings, Inc., Wilmington, DE (US)

(72) Inventors: Srinivas Gudumasu, Montreal (CA); Ahmed Hamza, Coquitlam (CA)

(73) Assignee: InterDigital VC Holdings, Inc., Wilmington, DE (US)

(21) Appl. No.: 19/171,034

(22) Filed: Apr. 4, 2025

(51) Int. Cl. H04L 41/50; H04L 41/0806; H04L 41/5067

(52) U.S. Cl. CPC H04L 41/5032; H04L 41/0806; H04L 41/5067

(57) ABSTRACT

Methods, systems and apparatuses are provided for collecting and reporting one or more common media client data (CMCD) metrics. A wireless transmit/receive unit (WTRU) may receive service access information from an application function (AF). The AF may establish a provisioning session with an application provider (AP) to receive provisioning information via a provisioning interface. The AF may generate and transmit service access information to the WTRU. The service access information may be indicative of a CMCD reporting scheme, a reporting type, and a reporting interval. The WTRU may collect the one or more CMCD metrics indicated by the CMCD reporting scheme. The WTRU may generate a report in a reporting format indicated by the CMCD reporting scheme. The WTRU may transmit the report with the AF via an interface using an in-band mechanism or an out-of-band mechanism, based the reporting type.

### BACKGROUND

In 5G media streaming (5GMS) systems, various media players on various devices may generate large amount of media consumption data. Various content delivery networks (CDNs) may generate large number of CDN logs for the media players. Correlating the media consumption data and the CDN logs is a challenge due to inconsistent reporting procedures. Therefore, there is a need to integrate CMCD into the 5GMS systems to develop standardized reporting procedures.

### SUMMARY

In one or more embodiments, a method performed by a wireless transmit/receive unit (WTRU) is provided. The method comprises receiving, from an application function (AF), service access information indicative of at least one of: a common media client data (CMCD) reporting scheme and a reporting type. The method comprises collecting, based on the CMCD reporting scheme, one or more CMCD metrics associated with a media streaming session. The method comprises generating, based on the one or more CMCD metrics, at least one CMCD metric report in a reporting format indicated by the CMCD reporting scheme. The method comprises transmitting, based on the reporting type, the at least one CMCD metric report to the AF and/or an application server (AS).

In an embodiment, the at least one CMCD metric report is transmitted to the AF via an interface using an out-of-band mechanism.

In an embodiment, the method comprises transmitting, to the AS, a media segment request comprising the at least one CMCD metric report.

In an embodiment, the media segment request is transmitted to the AS via an interface using an in-band mechanism.

In an embodiment, the reporting type is indicative of using the in-band mechanism or the out-of-band mechanism.

In an embodiment, the service access information is further indicative of a reporting interval for collecting the one or more CMCD metrics.

In an embodiment, the method comprises receiving a quality of experience (QoE) configuration including a trigger for collecting the one or more CMCD metrics.

In one or more embodiments, a wireless transmit/receive unit (WTRU) is provided. The WTRU comprises a transceiver and a processor. The transceiver and the processor are configured to receive, from an AF, service access information indicative of at least one of: a CMCD reporting scheme and a reporting type. The transceiver and the processor are configured to collect, based on the CMCD reporting scheme, one or more CMCD metrics associated with a media streaming session. The transceiver and the processor are configured to generate, based on the one or more CMCD metrics, at least one CMCD metric report in a reporting format indicated by the CMCD reporting scheme. The transceiver and the processor are configured to transmit, based on the reporting type, the at least one CMCD metric report to the AF and/or an AS.

In an embodiment, the at least one CMCD metric report is transmitted to the AF via an interface using an out-of-band mechanism.

In an embodiment, the transceiver and the processor are further configured to transmit, to the AS, a media segment request comprising the at least one CMCD metric report.

In an embodiment, the media segment request is transmitted to the AS via an interface using an in-band mechanism.

In an embodiment, the reporting type is indicative of using the in-band mechanism or the out-of-band mechanism.

In an embodiment, the service access information is further indicative of a reporting interval for collecting the one or more CMCD metrics.

In an embodiment, the transceiver and the processor are further configured to receive a QoE configuration including a trigger for collecting the one or more CMCD metrics.

In one or more embodiments, a method performed by an application function (AF) is provided. The method comprises establishing a provisioning session with an application provider (AP) via a provisioning interface. The method comprises receiving, from the AP during the provisioning session, provisioning configuration indicative of a common media client data (CMCD) reporting scheme or a reporting format. The method comprises transmitting, to a device via session handling interface, service access information indicative of at least one of: the CMCD reporting scheme or the reporting format.

In an embodiment, the method further comprises determining a reporting interval for collection of one or more CMCD metrics, wherein the service access information is indicative of the reporting interval.

In an embodiment, the method further comprises receiving, from the AP, a quality of experience (QoE) configuration including a trigger for initiating collection of one or more CMCD metrics.

In an embodiment, the method further comprises transmitting, to the device, an indication for transmitting one or more CMCD metrics via an interface using an in-band mechanism or an out-of-band mechanism.

In an embodiment, the method further comprises receiving, from the device, one or more CMCD metrics via an interface using an out-of-band mechanism.

In an embodiment, the method further comprises transmitting, to the AP, the received one or more CMCD metrics.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example 5G media streaming (5GMS) architecture according to one or more embodiments;

FIG. 3 illustrates an example 5GMS architecture according to one or more embodiments;

FIG. 4 illustrates a flow diagram for an example procedure for downlink media streaming according to one or more embodiments;

FIG. 5 is a flowchart illustrating a process performed by a wireless transmit/receive unit (WTRU) according to one or more embodiments; and

FIG. 6 is a flowchart illustrating a process performed by an application function (AF) according to one or more embodiments.

### DETAILED DESCRIPTION

As discussed herein, one or more abbreviations in the following (non-exhaustive) list, shown in Table 1, may be used herein.

TABLE 1

| | |
|---|---|
| 5G | Fifth Generation |
| 5GMS | 5G Media Streaming |
| 5GMSd | 5GMS downlink |
| 5GMSu | 5GMS uplink |
| 5G NR | Fifth Generation New Radio |
| 5GS | 5G System |
| AF | Application Function |
| AP | Application Provider |
| AR | Augmented Reality |
| AS | Application Server |
| CMCD | Common Media Client Data |
| DASH | Dynamic and Adaptive Streaming over HTTP |
| DN | Data Network |
| LTE | Long Term Evolution |
| MR | Mixed Reality |
| NEF | Network Exposure Function |
| NR | New Radio |
| NSMF | Network Slice Management Function |
| NSSAI | Network Slice Selection Assistance Information |
| NSSP | Network Slice Selection Policy |
| OAM | Operations, Administration and Maintenance |
| NTP | Network Time Protocol |
| QoE | Quality of Experience |
| RAN | Radio Access Network |
| RTC | Real-Time media Communication |
| RTP | Real-Time Protocol |
| SRC | Spilt-Rendering Client |
| SR-MSE | Spilt-Rendering Media Service Enabler |
| TR | Technical Report |
| TS | Technical Specification |
| UE | User Equipment |
| URN | Uniform Resource Name |
| VolP | Voice over IP |
| WEBRTC | Web Real-Time Communication |
| XR | Extended Reality |

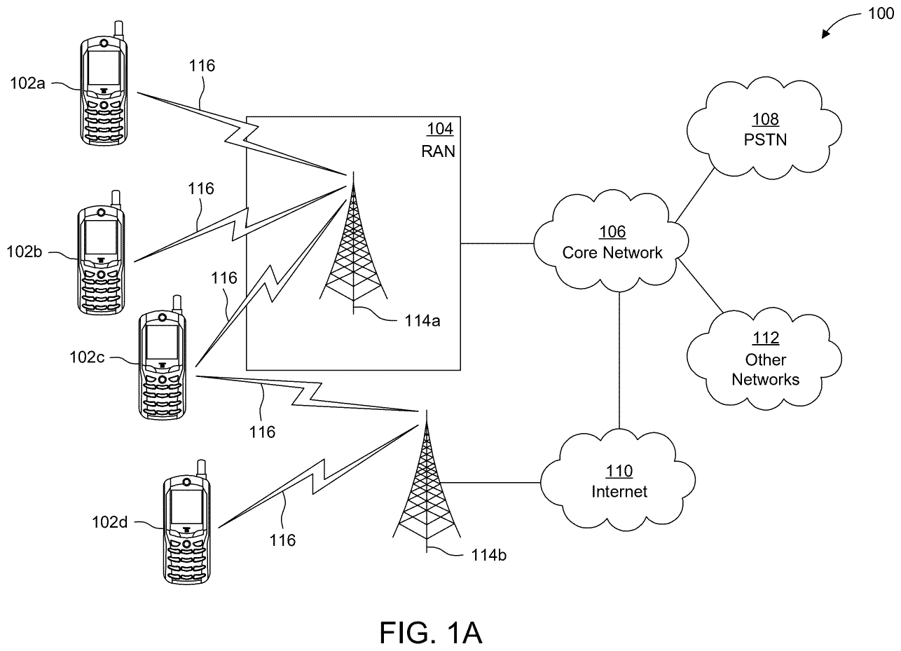

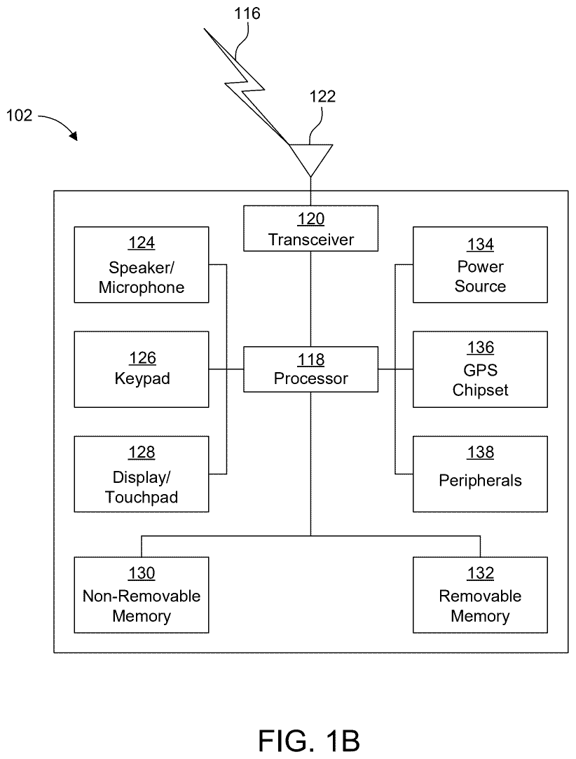

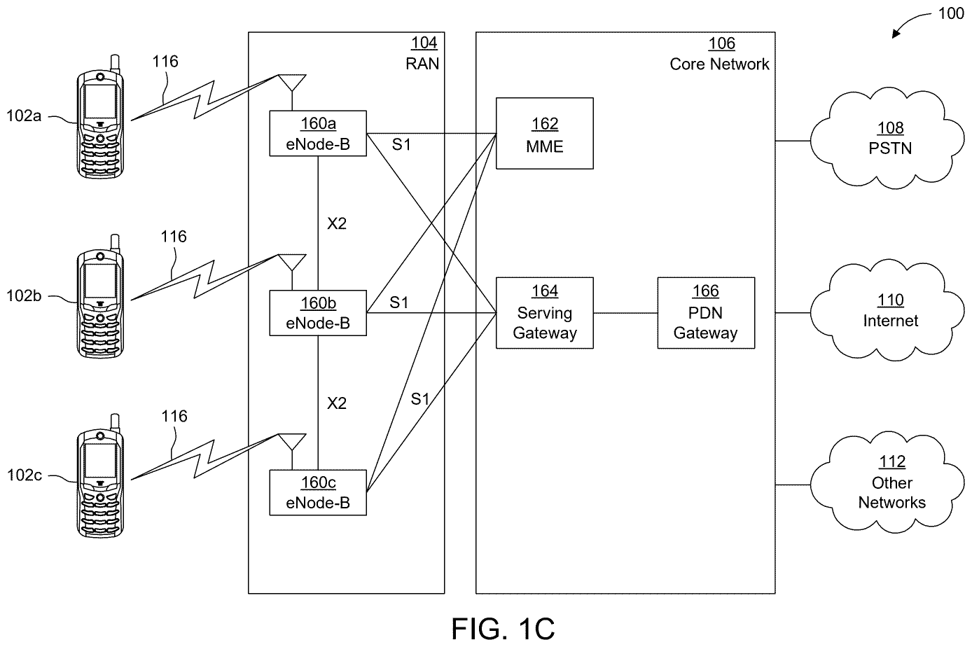

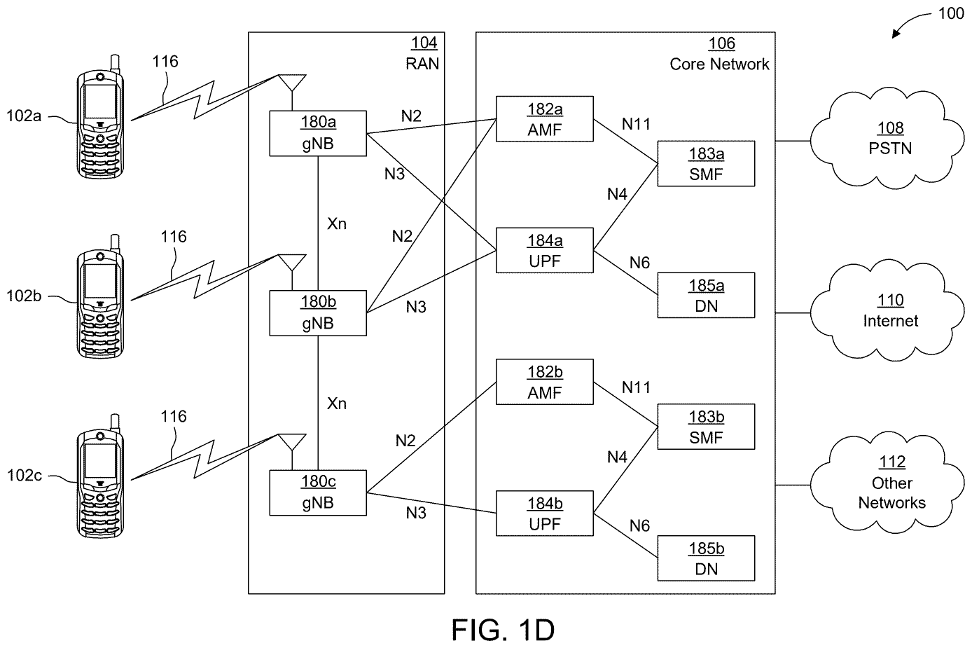

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Typically, most commercial analytics solutions send data related to media consumption information from a media player to a server. Volume of such consumption information related data is enormous on both ends of delivery pipeline. Similarly, one or more logs from one or more content distribution network (CDN) providers also provide one or more media clients data to one or more reporting servers. In an implementation, a common media client data (CMCD) specification by consumer technology association (CTA)—web application video ecosystem (WAVE) provides various solutions for associating client-side data with one or more CDN logs.

To support a CMCD reporting feature in various fifth generation (5G) media streaming services which use 3^{rd} generation partnership project (3GPP) 5G system networks, one or more methods and systems for provisioning configuration application programming interface (API) and for enabling one or more CMCD metrics collection and reporting are provided in one or more embodiments. In an embodiment, a metrics reporting configuration shared via server access information between a 5GMS client and a media application function (AF) is provided. In one or more embodiments, a 3GPP scheme, a reporting protocol and JavaScript object notation (JSON) based-report format for reporting one or more CMCD metrics both in-band and out-of-band are provided.

Various methods, systems, and apparatuses of the present disclosure relate to advanced media delivery (AMD), 5GMS, 5GMS_Pro_Ph2, one or more APIs and one or more protocols for one or more interfaces, and/or CMCD, for example.

In an implementation, an updated provisioning configuration API for enabling the one or more CMCD metrics collection and reporting feature in a 5GMS media streaming session is described.

In an implementation, an updated metrics reporting configuration property in service access information of M5 API for enabling one or more CMCD metrics collection and reporting feature in a 5GMS media streaming session is described.

In an implementation, a 3GPP scheme, a reporting protocol and a JSON based-report format for reporting the one or more CMCD metrics both in-band and out-of-band are provided.

Typically, most commercial analytics solutions send consumption information related data from one or more players to one or more servers every N seconds with a lot of segment-level information such as measured bandwidth, one or more data rates of one or more requested segments, buffering, one or more playback events, and the like. In an example, a snapshot of an entire streaming session from start to finish is provided with the segment level information. There are various challenges in correlating one or more logs from one or more CDN providers, e.g., CDN data with client-side data. The volume of consumption information related data is enormous on both ends of the delivery pipeline.

In an implementation, one or more embodiments of the present disclosure provide a protocol to standardize the information definition, exchange, and logging.

In an implementation, the CMCD specification provides joining and/or associating the client-side data with the one or more CDN logs. The CMCD specification provides a technique by which every media player can communicate data with each media object request, and receive and process the media object request consistently for every CDN.

While 3GPP and moving picture experts group (MPEG) in dynamic adaptive streaming over hypertext transfer protocol (HTTP), DASH, support one or more DASH metrics, reporting is not common to any player, for example all DASH players as well as HTTP live streaming (HLS) players. In an implementation, a technique for integration of one or more metrics is provided. Various metric keys, player APIs, sending options from a client to a server (e.g., user plane, M5 reference point, data collection and reporting, M3 reference point impact etc.), and usage of the data in one or more operations may be supported.

In an embodiment, CMCD includes a set of media client data, structured as key/value pairs, that allows a media player to communicate mutually beneficial media-related information to a CDN via (i) a set of custom headers, (ii) a uniform resource locator (URL) request query string, and/or (iii) a JSON object. In an example, the same data structure may be used across all players and all CDNs.

In an embodiment, streaming includes delivery of time-continuous media as predominant media. In an example, in streaming, the media may be predominantly sent in a single direction and consumed as it is received. Additionally, the media content may be streamed as it is produced, referred to as live streaming. If the content is streamed that is already produced, it is referred to as on-demand streaming.

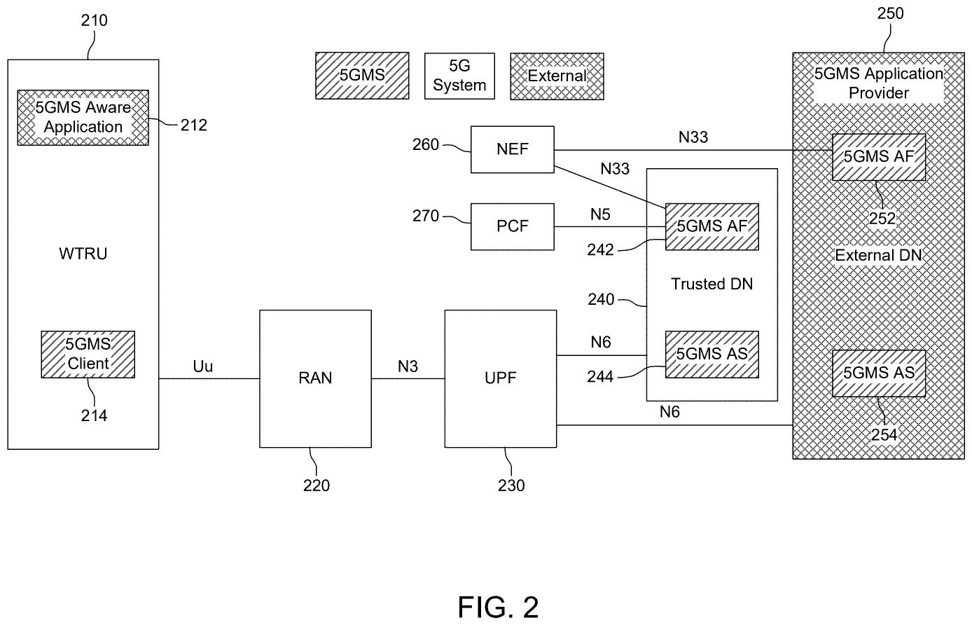

Referring now to FIG. 2, an example 5G media streaming (5GMS) architecture is illustrated according to one or more embodiments. The 5GMS architecture includes a wireless transmit/receive unit (WTRU) 210, a radio access network (RAN) node 220, a user plane function (UPF) 230, a trusted data network (DN) 240, a 5GMS application provider (AP) 250 in an external DN, a network exposure function (NEF) 260, and a policy control function (PCF) 270. The WTRU 210 includes a 5GMS aware application (212) and a 5GMS client 214. The trusted DN 240 includes a first 5GMS MF 242 and a first 5GMS AS 244. The 5GMS AP 250 in the external DN includes a second 5GMS AF 252 and a second 5GMS AS 254. The 5GMS architecture illustrates 5G media streaming within a 5G system. As shown in FIG. 2, the WTRU 210 and the RAN node 220 communicate via Uu interface. The RAN node 220 and the UPF 230 communicate via N3 interface. The UPF 230 and the DNs (e.g., the trusted DN 240 and the external DN) communicate via N6 interface. The DNs communicate with the NEF 260 and the PCF 270 via N33 and N5 interfaces respectively.

The 5GMS AP 250 uses 5GMS for one or more streaming services. The 5GMS AP 250 may provide the 5GMS aware application 212 on the WTRU 210 to make use of one or more 5GMS client and network functions using one or more interfaces and one or more APIs defined in the 5GMS.

The first 5GMS AF 242 in the trusted DN 240 and/or the second 5GMS AF 252 in the external DN may be application functions dedicated to 5G media streaming.

The first 5GMS AS 244 in the trusted DN 240 and/or the second 5GMS AS 254 in the external DN may be application servers dedicated to 5G media streaming.

The 5GMS client 214 in the WTRU 210 may be a WTRU internal function dedicated to 5G media streaming. The 5GMS client 214 is a logical function and one or more subfunctions of the 5GMS client 214 may be distributed within the WTRU 210 in various implementations.

The first 5GMS AF 242, the second 5GMS AF 252, the first 5GMS AS 254 and/or the second 5GMS AS 254 may be various DN functions and may communicate with the WTRU 210 via N6 interface.

In an example, various functions in one or more trusted DNs, e.g. the first 5GMS AF 242 in the trusted DN 240, may be trusted by an operator's network. Therefore, one or more such AFs may directly communicate with one or more relevant 5G core functions.

In an example, various functions in one or more external DNs, e.g. the second 5GMS AF 252 in the external DN, may only communicate with one or more 5G core functions via the NEF 260 using N33.

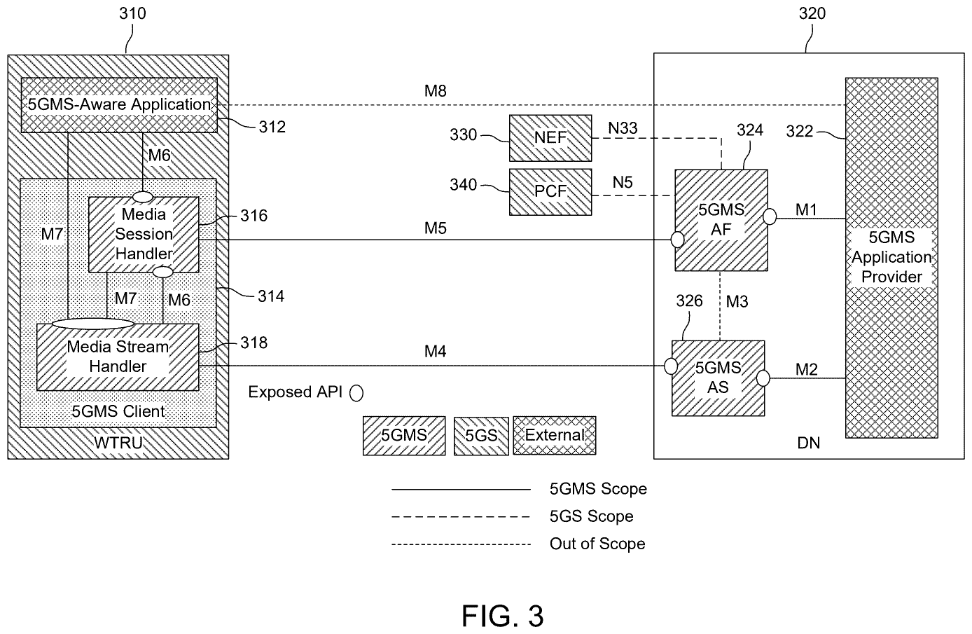

Referring now to FIG. 3, an example 5G media streaming architecture is illustrated according to one or more embodiments. The 5G media services architecture includes a WTRU 310, a DN 320, a NEF 330, and a PCF 340. The WTRU 310 includes a 5GMS aware application 312 and a 5GMS client 314. The 5GMS client 314 includes a media session handler 316 and a media stream handler 318. The DN 320 includes 5GMS AP 322, a 5GMS AF 324, and a 5GMS AS 326.

The 5GMS client 314 in the WTRU 310 includes the media session handler 316 and the media stream handler 318 functions which expose one or more APIs to one another in the same way that those APIs are exposed to one or more 5GMS aware applications.

In an implementation, in downlink streaming, the network is the origin of the media and the WTRU 310 acts as a consumption device.

In an implementation, in uplink streaming, the WTRU 310 is the origin of the media and the network acts as a consumption entity.

In an implementation, a media AF (e.g., the 5GMS AF 324) may be an AF dedicated to 5G media delivery. The media AS 326 may be an AS dedicated to 5G media delivery. The media client 314 may be a WTRU internal function dedicated to 5G media delivery. The media session handler 316 may be a function on the WTRU 310 that communicates with the media AF (e.g., the 5GMS AF 324) to establish, control and/or support the delivery of a media session. The media AF may also be a WTRU internal function, e.g. a function on the WTRU 310 that communicates with the media AS (e.g., the 5GMS AS 326) to access and/or deliver media content. The media access function for example may be further sub-divided into one or more content delivery protocols, codecs, media types and/or metadata representation.

In an implementation, the following interfaces and APIs may be used for 5G media delivery. For M1, a provisioning API may include an external API, exposed by the media AF which enables the media application provider (e.g., the 5GMS AP 322) to provision the usage of the 5G media delivery and to obtain feedback.

For M2, a user plane interface may include an external interface provided by the media AS (e.g., the 5GMS AS 326) and used when the media AS in the trusted DN to exchange data media data with the application service provider.

For M3, a server configuration API may include an API used to exchange information between the media AF and the media AS for configuration purposes.

For M4, a media delivery interface may include an interface and a reference point between a media access function and a media AS to exchange media content.

For M5, a session handling API may include one or more APIs exposed by a media AF to the media session handler 316 for media session handling, control, reporting and/or assistance that also includes one or more security mechanisms, e.g. authorization and authentication etc., for example.

For M6, one or more client configuration APIs include one or more APIs exposed by the media session handler 316 to the application and the media access function for client-internal communication.

For M7, one or more media access APIs include one or more APIs exposed by the media access function to configure and/or communicate with the media access function.

For M8, an application reference point includes an application interface used for information exchange between the media application and the media application provider.

In an embodiment, one or more procedures for downlink media streaming using different 5G media streaming reference points and/or procedures for uplink media streaming using one or more 5GMS reference points are provided.

In an embodiment, one or more M1 interface provisioning procedures for reporting one or more metrics used by the 5GMS AP 322 to configure one or more quality of experience (QoE) metrics reporting functionality associated with downlink and/or uplink media streaming are provided. In an embodiment, one or more procedures such as creating, reading, updating and/or destroying the one or more metrics report configuration may be used. In an embodiment, one or more M5 APIs may be used by the media session handler 316 within the 5GMS client 314 to invoke one or more services relating to downlink and/or uplink media streaming at the 5GMS AF 324.

In an embodiment, one or more M5 procedures for the one or more quality of experience (QoE) metrics reporting pertain to a combination of the provisioning of the one or more metrics collection and reporting in the media session handler 316 using relevant service access information, and the sending one or more collected metrics by the media session handler to the 5GMS AF 324 in accordance with one or more configured metrics schemes. In an example, a metrics scheme may be 3GPP-defined or non-3GPP-defined.

When the metrics collection and reporting feature is activated for a downlink media streaming session, one or more metrics configuration sets, each associated with a metrics scheme, may be provided to the 5GMS client 314. A given metrics configuration set may include information such as but not limited to one or more 5GMS AF addresses to which the one or more metrics are to be sent by the media session handler 316, a metrics reporting interval, a target percentage of media streaming sessions for which reports should be sent, and the set of metrics to be collected and/or reported.

For one or more DASH streaming services, one or more listed metrics in a given metrics configuration set may be associated with the 3GPP metrics scheme.

For submitting a metrics report, the media session handler 316 may send an HTTP POST message to the 5GMS AF 324.

In an implementation, 5G media streaming supports the metrics measurement, collection and reporting procedures in St system (5G) networks. These procedures are performed by the media AF of the 5GS network, a media session handler running on a device (e.g., a WTRU) connected to a RAN of a system (e.g., the 5GS) network.

In an example, a list of CMCD metrics documented in the CMCD specification are listed in Table 2.

TABLE 2

| | Key | Header | | |
|---|---|---|---|---|
| Description | Name | Name | Type & Unit | Value definition |
| Encoded | bt | CMCD- | Integer kbps | The encoded bitrate of the audio or video object being |
| bitrate | | Object | | requested. This may not be known precisely by the player; |
| | | | | however, it MAY be estimated based upon playlist/manifest |
| | | | | declarations. If the playlist declares both peak and average |
| | | | | bitrate values, the peak value may be transmitted. |
| Buffer length | bl | CMCD- | Integer | The buffer length associated with the media object being |
| | | Request | milliseconds | requested. This value MUST be rounded to the nearest |
| | | | | 100 ms. This key SHOULD only be sent with an object type |
| | | | | of ‘a’, ‘v’or ‘av’. |
| Buffer | bs | CMCD- | Boolean | Key is included without a value if the buffer was starved at |
| starvation | | Status | | some point between the prior request and this object |
| | | | | request, resulting in the player being in a rebuffering state |
| | | | | and the video or audio playback being stalled. This key |
| | | | | MUST NOT be sent if the buffer was not starved since the |
| | | | | prior request. |
| | | | | If the object type ‘ot’ key is sent along with this key, then |
| | | | | the ‘bs’ key refers to the buffer associated with the |
| | | | | particular object type. If no object type is communicated, |
| | | | | then the buffer state applies to the current session. |
| Content ID | cid | CMCD- | String | A unique string identifying the current content. Maximum |
| | | Session | | length is 64 characters. This value is consistent across |
| | | | | multiple different sessions and devices and is defined and |
| | | | | updated at the discretion of the service provider. |
| Object | d | CMCD- | Integer | The playback duration in milliseconds of the object being |
| duration | | Object | milliseconds | requested. If a partial segment is being requested, then this |
| | | | | value MUST indicate the playback duration of that part and |
| | | | | not that of its parent segment. This value can be an |
| | | | | approximation of the estimated duration if the explicit value |
| | | | | is not known. |
| Deadline | dl | CMCD- | Integer | Deadline from the request time until the first sample of this |
| | | Request | milliseconds | Segment/Object needs to be available in order to not |
| | | | | create a buffer underrun or any other playback problems. |
| | | | | This value MUST be rounded to the nearest 100 ms. For a |
| | | | | playback rate of 1, this may be equivalent to the player's |
| | | | | remaining buffer length. |
| Measured | mtp | CMCD- | Integer | The throughput between client and server, as measured by |
| throughput | | Request | kilobits per | the client and MUST be rounded to the nearest 100 kbps. |
| | | | second (kbps) | This value, however derived, SHOULD be the value that |
| | | | | the client is using to make its next Adaptive Bitrate |
| | | | | switching decision. If the client is connected to multiple |
| | | | | servers concurrently, it must take care to report only the |
| | | | | throughput measured against the receiving server. If the |
| | | | | client has multiple concurrent connections to the server, |
| | | | | then the intent is that this value communicates the |
| | | | | aggregate throughput the client sees across all those |
| | | | | connections. |
| Next object | nor | CMCD- | String | Relative path of the next object to be requested. This can |
| request | | Request | | be used to trigger pre-fetching by the CDN. This MUST be |
| | | | | a path relative to the current request. This string MUST be |
| | | | | URLEncoded. The client SHOULD NOT depend upon any |
| | | | | pre-fetch action being taken - it is merely a request for such |
| | | | | a pre-fetch to take place. |
| Next range | nrr | CMCD- | String of the | If the next request will be a partial object request, then this |
| request | | Request | form “<range- | string denotes the byte range to be requested. If the ‘nor’ |
| | | | start>- | field is not set, then the object is assumed to match the |
| | | | <range-end>” | object currently being requested. The client SHOULD NOT |
| | | | | depend upon any pre-fetch action being taken - it is merely |
| | | | | a request for such a pre-fetch to take place. Formatting is |
| | | | | similar to the HTTP Range header, except that the unit |
| | | | | MUST be ‘byte’, the ‘Range:’ prefix is NOT required and |
| | | | | specifying multiple ranges is NOT allowed. Valid |
| | | | | combinations are: |
| | | | | “<range-start>-” |
| | | | | “<range-start> -< range-end>” |
| | | | | “ _< suffix-length>” |
| Object type | ot | CMCD- | Token - one of | The media type of the current object being requested: |
| | | Object | [m, | m = text file, such as a manifest or playlist |
| | | | a, v, av, i, c, tt, | a = audio only |
| | | | k, o] | v = video only |
| | | | | av = muxed audio and video |
| | | | | i = init segment |
| | | | | c = caption or subtitle |
| | | | | tt = ISOBMFF timed text track |
| | | | | k = cryptographic key, license or certificate. |
| | | | | o = other |
| | | | | If the object type being requested is unknown, then this key |
| | | | | MUST NOT be used. |
| Playback rate | pr | CMCD- | Decimal | 1 if real-time, 2 if double speed, 0 if not playing. SHOULD |
| | | Session | | only be sent if not equal to 1. |
| Requested | rtp | CMCD- | Integer | The requested maximum throughput that the client |
| maximum | | Status | kilobits per | considers sufficient for delivery of the asset. Values MUST |
| throughput | | | second (kbps) | be rounded to the nearest 100 kbps. For example, a client |
| | | | | would indicate that the current segment, encoded at |
| | | | | 2 Mbps, is to be delivered at no more than 10 Mbps, by |
| | | | | using rtp = 10000. |
| | | | | Note: This can benefit clients by preventing buffer |
| | | | | saturation through over-delivery and can also deliver a |
| | | | | community benefit through fair-share delivery. The concept |
| | | | | is that each client receives the throughput necessary for |
| | | | | great performance, but no more. The CDN may not support |
| | | | | the rtp feature. |
| Streaming | sf | CMCD- | Token - one of | The streaming format that defines the current request. |
| format | | Session | [d, h, s, o] | d = MPEG DASH |
| | | | | h = HTTP Live Streaming (HLS) |
| | | | | s = Smooth Streaming |
| | | | | o = other |
| | | | | If the streaming format being requested is unknown, then |
| | | | | this key MUST NOT be used. |
| Session ID | sid | CMCD- | String | A GUID identifying the current playback session. A |
| | | Session | | playback session typically ties together segments |
| | | | | belonging to a single media asset. Maximum length is 64 |
| | | | | characters. It is RECOMMENDED to conform to the UUID |
| | | | | specification. |
| Stream type | st | CMCD- | Token - one of | v = all segments are available - e.g., VOD |
| | | Session | [v, l] | l = segments become available over time - e.g., LIVE |
| Startup | su | CMCD- | Boolean | Key is included without a value if the object is needed |
| | | Request | | urgently due to startup, seeking or recovery after a buffer- |
| | | | | empty event. The media SHOULD not be rendering when |
| | | | | this request is made. This key MUST not be sent if it is |
| | | | | FALSE. |
| Top bitrate | tb | CMCD- | Integer Kbps | The highest bitrate rendition in the manifest or playlist that |
| | | Object | | the client is allowed to play, given current codec, licensing |
| | | | | and sizing constraints. |
| CMCD | V | CMCD- | Integer | The version of this specification used for interpreting the |
| version | | Session | | defined key names and values. If this key is omitted, the |
| | | | | client and server MUST interpret the values as being |
| | | | | defined by version 1. Client SHOULD omit this field if the |
| | | | | version is 1. |

Various embodiments provide establishing a provisioning session and a media streaming session between a media AP, a media AF and a 5G media streaming device. One or more embodiments also provide transmitting provisioning session information using M1 interface and service access information using M5 interface. To enable the CMCD reporting feature in one or more 5G media streaming services, the media AP may configure the media application function in the provisioning session creation. The media AF may send one or more CMCD metrics collection and reporting feature support information to one or more 5G media streaming client devices. The reporting protocol and JSON based-report format for reporting the one or more CMCD metrics information from the 5G media streaming client to media AS and/or media AF are provided.

Various embodiments provide methods and systems for provisioning configuration API for enabling CMCD metrics collection and reporting feature. One or more embodiments provide metrics reporting configuration shared via a server access information between a 5GMS client and a media AF. Various methods and systems also provide a 3GPP scheme, a reporting protocol and/or JSON based-report format for reporting the one or more CMCD metrics both in-band and out-of-band mechanisms, interfaces, and/or signaling.

Various embodiments provide a CMCD provisioning configuration, and a metrics reporting provisioning API. The metrics reporting provisioning API allows a media application provider to configure the metrics collection and reporting procedure for a particular downlink or uplink media delivery provisioning session at reference point M1.

The metrics reporting provisioning API may be extended to configure the CMCD metrics reporting procedure for both in-band and out-of-band reporting. The MetricsReportingConfiguration resource used in metrics reporting provisioning API may include a reportingType field of type boolean to indicate the CMCD metrics reporting type. A value 0 indicates the CMCD reporting as in-band reporting and a value 1 indicates the CMCD reporting as out-of-band reporting.

The resource structure and the data model for the one or more metrics are provided. The metrics reporting scheme may be signaled using in the Scheme@schemeldUri property of the MetricsReportingConfiguration resource. The URN urn:3GPP:ns:PSS:CMCD:QM1 may be indicated in this property.

A media client supporting CMCD metrics may report the one or more CMCD metrics according to a QoE configuration. When CMCD metrics supporting is enabled, a media client may report all requested metrics.

The one or more CMCD metrics for downlink media streaming session are provided. In this case, QoE reporting may be triggered using the OMA DM QoE management object, or by the QMC functionality. When the QoE reporting is triggered via any of the above methods, the media client is expected to collect the one or more CMCD metrics according to the QoE configuration. When using the OMADM and/or the QMC functionality, the quality reporting scheme may be used.

The QoE configuration may be evaluated by the media client at the start of a QoE measurement and reporting session (e.g., a QoE session) associated with a downlink and/or uplink streaming session. This includes evaluation of any filtering criteria such as by geographical area. Client evaluation of all measurement and reporting criteria for an ongoing QoE session may be unaffected by any QoE configuration changes received during that session, for e.g., any changes to the QoE configuration may affect one or more QoE sessions started after these configuration changes have been received.

A quality metric reporting protocol may be used when CMCD reporting is triggered via the OMA DM QoE management object. When the CMCD reporting is triggered via the QMC functionality, the QoE configuration is received via one or more specific radio resource control (RRC) messages for UMTS, RRC messages for LTE, and RRC messages for NR over the control plane, and the CMCD reporting may also be sent back via RRC messages over the control plane. The one or more CMCD metrics from the media client may be JSON-based.

A 5GMS media client may use a data model for metrics reporting provisioning API. In another embodiment, the metrics element in the MetricsReportingConfiguration resource may include zero or more CMCD metrics.

The service access information (SAI) resource structure and the data model for client metrics reporting configuration are provided. The metrics reporting scheme is signaled in a Scheme@schemeldUri property of a clientMetricsReportingConfigurations present in the ServiceAccesslnformation resource. The URN urn:3GPP:ns:PSS:CMCD:QM1 may be indicated in the scheme property.

The scheme property in the clientMetricsReportingConfigurations of the ServiceAccessInformation resource may include support for signaling one or more schemes.

In another embodiment ServiceAccesslnformation resource may have multiple clientMetricsReportingConfigurations objects where one for signaling the CMCD data collection and reporting and others for different QoE metrics collection and reporting. The clientMetricsReportingConfigurations resource of ServiceAccesslnformation resource used in the service access information API may include a reportingType field of type boolean to indicate the CMCD metrics reporting type. A value 0 indicates the CMCD reporting as in-band reporting and a value 1 indicates the CMCD reporting as out-of-band reporting.

In an implementation, the quality metrics reporting protocol may use out-of-band JSON based CMCD reporting.

In an embodiment, the media session handler in the media client may report CMCD information to the 5GMSd AF at reference point M5d.

In another embodiment, the media AS may report CMCD information to the 5GMSd AF at reference point Md.

The quality metrics reporting protocol may include a JSON-based report format.

A MIME type of a JSON-formatted CMCD report data may be “application/3gpdash-cmcd-report+json”.

For JSON report format may include the CMCD data may be formatted as a JSON document that complies with a JSON schema in Table 3.

TABLE 3

```
{
  “$schema” : “http://json-schema.org/draft-07/schema”,
  “title” : “CMCD data report”,
  “type” : “object”,
  “description”: “report for CMCD data”,
  “properties” : {
    “bl”: {
      “type”: “integer”,
      “description”: “The buffer length associated with the media object being requested. This value MUST be rounded
to the nearest 100 ms.”,
    },
    “br”: {
      “type”: “integer”,
      “description”: “The encoded bitrate of the audio or video object being requested. This value is expressed in
kilobits per second (kbps)”,
    },
    “bs”: {
      “type”: “boolean”,
      “description”: “Key is included without a value if the buffer was starved at some point between the prior request
and this object request, resulting in the player being in a rebuffering state and the video or audio playback being stalled.
This key SHALL not be sent if the buffer was not starved since the prior request.”,
    },
    “cid”: {
      “type”: “string”,
      “description”: “A unique string identifying the current content. This value is consistent across multiple different
sessions and devices and is defined and updated at the discretion of the service provider.”,
    },
    “d”: {
      “type”: “integer”,
      “description”: “The playback duration in milliseconds of the object being requested. If a partial segment is being
requested, then this value MUST indicate the playback duration of that part and not that of its parent segment.”,
    },
    “dl”: {
      “type”: “integer”,
      “description”: “Deadline from the request time until the first sample of this Segment/Object needs to be available
in order to not create a buffer underrun or any other playback problems. This value MUST be rounded to the nearest
100ms.”,
    },
    “mtp”: {
      “type”: “integer”,
      “description”: “Deadline from the request time until the first sample of this Segment/Object needs to be available
in order to not create a buffer underrun or any other playback problems. This value MUST be rounded to the nearest
100ms.”,
    },
    “nor”: {
      “type”: “string”,
      “description”: “Relative path of the next object to be requested.”,
    },
    “nor”: {
      “type”: “string”,
      “description”: “Relative path of the next object to be requested.”,
    },
    “nrr”: {
      “type”: “string”,
      “description”: “If the next request will be a partial object request, then this string denotes the byte range to be
requested.”,
    },
    “ot”: {
      “type”: “string”,
      “description”: “The media type of the current object being requested.”,
    },
    “pr”: {
      “type”: “number”,
      “description”: “1 if real-time, 2 if double speed, 0 if not playing. SHOULD only be sent if not equal to 1.”,
    },
    “rtp”: {
      “type”: “integer”,
      “description”: “The requested maximum throughput that the client considers sufficient for delivery of the asset.
Values MUST be rounded to the nearest 100kbps.”,
    },
    “sf”: {
      “type”: “string (d, h, s or o)”,
      “description”: “The streaming format which defines the current request. d = MPEG DASH; h = HLS; s = Smooth
Streaming; o = Other”,
    },
    “sid”: {
      “type”: “String”,
      “description”: “A GUID identifying the current playback session.”,
    },
    “st”: {
      “type”: “string (v or I)”,
      “description”: “v = VOD; I = LIVE.”,
    },
    “su”: {
      “type”: “boolean”,
      “description”: “Key is included without a value if the object is needed urgently due to startup, seeking or recovery
after a buffer-empty event. This key SHALL not be sent if it is false.”,
    },
    “tb”: {
      “type”: “integer”,
      “description”: ” The highest bitrate rendition in the manifest or playlist that the client is allowed to play, given
current codec, licensing and sizing constraints.”,
    },
    “v”: {
      “type”: “integer”,
      “description”: ” The version of this specification used for interpreting the defined key names and values. Client
SHOULD omit this field if the version is 1 and interpret it as 1.”,
    },
    “extensions”: { },
    “extras”: { }
  },
  “required”: [“”]
}
```

For 5G downlink media streaming services, the required MIME content type and metrics report format for the 3GPP urn:3GPP:ns:PSS:CMCD:QM1 metrics reporting scheme are provided.

For configuration done via the QMC functionality, the 5G media streaming client may send the one or more CMCD metrics reports via the QMC functionality. For OMA-DM configuration, if a specific metrics server has been configured, the client may send the one or more CMCD metrics reports using the HTTP POST request carrying JSON-formatted data in its body.

For in-band reporting of the one or more CMCD metrics reports to a media AS, the 5G media streaming client may send the CMCD metrics reports as part of the media segment requests using a CMCD query parameter and/or one or more CMCD request headers. In another embodiment, the 5G media streaming client may also send the one or more CMCD metrics reports as part of one or more media segment requests by adding a CMCD JSON object to the requested URL and/or URN.

In an embodiment, in a CMCD Reporting Scheme for media client, the URN to be used for the Scheme@schemeldUri may be “urn:3GPP:ns:PSS:CMCD:QM1”. The metrics reporting provisioning API may allow an 5GMS application provider to configure the metrics collection and reporting procedure for a downlink media streaming session at reference point M1.

In the case of downlink media streaming, the one or more CMCD metrics may be reported according to a quality reporting scheme disclosed above.

For in-band reporting of the CMCD metric information, the one or more CMCD metrics may be formatted as a header field and/or one or more query arguments. This information may be part of the HTTP GET request for a media object at M4d interface.

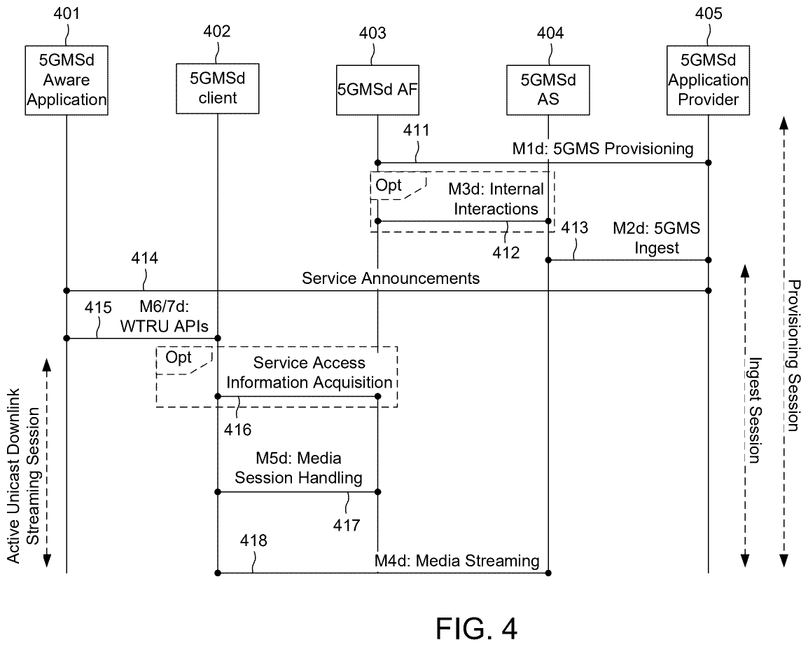

Referring now to FIG. 4, a flow diagram for an example procedure for downlink media streaming is illustrated according to one or more embodiments. The downlink media streaming may be performed between a 5GMSd aware application 401, a 5GMSd client 402, a 5GMSd AF 403, a 5GMSd AS 404, and a 5GMSd application provider 405.

The downlink streaming procedure follows the workflow depicted in FIG. 4, starting from provisioning and ingest session preparation to the actual content streaming sessions. The ingest session refers to a time interval during which media content is uploaded to the 5GMSd AS 404. The provisioning session refers to the time interval during which the 5GMSd client 402 may access the media content and the 5GMSd application provider 405 may control and monitor the media content and its delivery. Interaction between the 5GMSd AF 403 and the 5GMSd application provider 405 may occur at any time while the provisioning session is active.

The 5GMSd provisioning API at M1d allows selection of one or more media session handling (M5d) and/or media streaming (M4d) options, including whether the media content is hosted on one or more trusted 5GMSd AS instances. The one or more provisioned 5GMSd features may be captured in a provisioning session that is uniquely identified in the 5GMS system by a provisioning session identifier. The provisioning session information may include content hosting configurations, content preparation templates, server certificates, policy templates, a consumption reporting configuration, metrics reporting configurations, edge resources configurations and event data processing configurations.

The consumption reporting and/or metrics reporting configuration information provisioned over M1d and passed to the 5GMSd client 402 by the 5GMSd AF 403 over M5d determines the WTRU data to be collected by the 5GMSd client 402 and subsequently reported to the 5GMSd AF 403.

At 411, the 5GMSd application provider 405 creates a provisioning session with the 5GMSd AF 403 and starts provisioning the usage of the 5G media streaming system. During the establishment phase, the used features are negotiated and detailed configurations are exchanged. The 5GMSd AF 403 receives service access information for M5d (media session handling) and, where media content hosting is negotiated, and M4d (media streaming) as well. This information is needed by the 5GMSd client 402 to access the service. Depending on the provisioning, only a reference to the service access information might be supplied.

At 412, when content hosting is offered and selected there may be interactions between the 5GMSd AF 503 and the 5GMSd AS 404 at reference point M3d, e.g., to configure one or more server certificates and/or one or more content preparation templates and to allocate 5GMSd content ingest and distribution resources by providing a content hosting configuration. The 5GMSd AS 404 may provide one or more resource identifiers for the allocated resources to the 5GMSd AF 403, which then provides the information to the 5GMSd application provider 405.

At 413, the 5GMSd application provider 405 starts the ingest session by ingesting content. In case of live services, the content is continuously ingested. In case of on-demand streaming services, the content may be uploaded once and then updated later on.

In an example, a 5GMSd AS in an external DN may provide content hosting.

At 414, the 5GMSd application provider 405 provides the service announcement information to the 5GMSd aware application 401. The service announcement includes either the whole service access information (i.e. details for media session handling (M5d) and for media streaming access (M4d)) or a reference to the service access information and/or pre-configured information. When only a reference is included, the 5GMSd client 402 may fetch (at 416) the services access information when needed. In a specific case, the 5GMSd service may be announced using a 3GPP service URL that may launch the service.

At 415, when the 5GMSd aware application 401 may decide to begin streaming, the service access information (all or a reference) may be provided to the 5GMSd client 402. The 5GMSd client 402 may activate the unicast downlink streaming session.

At 416, in case the 5GMSd client 402 received only a reference to the service access information, then it acquires the service access information from the 5GMSd AF 403.

In an example, pre-caching of service access information may also be supported by the 5GMS client 402 to speed up the activation of the service.

At 417, the 5GMSd client 402 uses the media session handling API exposed by the 5GMSd AF 403 at M5d. The media session handling API is used for configuring content consumption measurement, logging, collection and/or reporting; configuring one or more QoE metrics measurement, logging, collection and/or reporting; requesting different policy and/or charging treatments; or 5GMSd AF-based network assistance. The actual time of API usage depends on the feature and interactions that may be used during the media content reception.

At 418, the 5GMSd client 402 may activate reception of the media content.

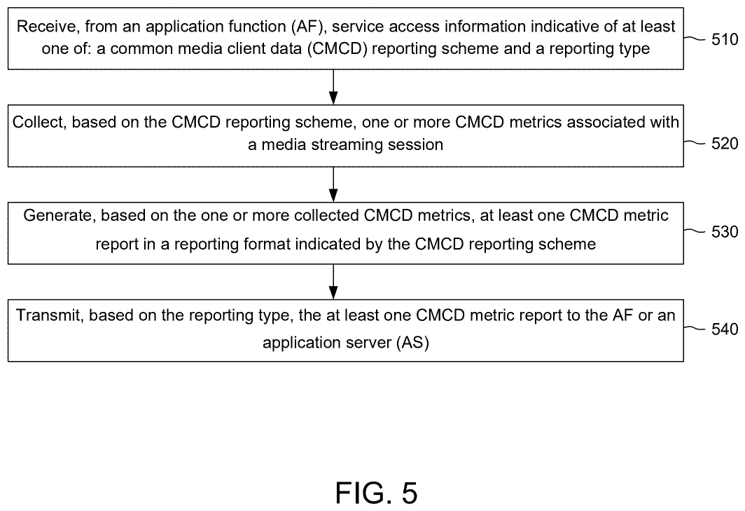

FIG. 5 is a flowchart illustrating a process performed by a WTRU according to one or more embodiments.

At 510, the WTRU may receive, from an AF, service access information indicative of at least one of: a CMCD reporting scheme and a reporting type. The reporting type may be indicative of using an in-band mechanism or an out-of-band mechanism. The service access information may be further indicative of a reporting interval for collecting the one or more CMCD metrics. The CMCD reporting scheme may be further indicative of a reporting format. The WTRU may receive a QoE configuration including a trigger for collecting the one or more CMCD metrics

At 520, the WTRU may collect, based on the CMCD reporting scheme, one or more CMCD metrics associated with a media streaming session.

At 530, the WTRU may generate, based on the one or more collected CMCD metrics, at least one CMCD metric report in the reporting format.

At 540, the WTRU may transmit, based on the reporting type, the at least one CMCD metric report to the AF and the AS. In an example, the at least one CMCD metric report may be transmitted to the AF via the interface using the out-of-band mechanism. In an example, the WTRU may transmit, to an AS, a media segment request comprising the at least one CMCD metric report. The media segment request is transmitted to the AS via the interface using the in-band mechanism.

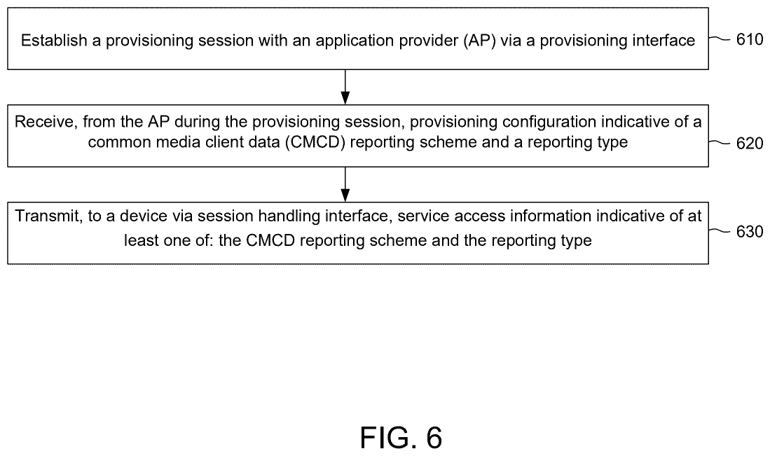

FIG. 6 is a flowchart illustrating a process performed by an AF according to one or more embodiments.

At 610, the AF may establish a provisioning session with an AP via a provisioning interface.

At 620, the AF may receive, from the AP during the provisioning session, provisioning configuration indicative of a CMCD reporting scheme and a reporting type. The AF may receive, from the AP, a QoE configuration including a trigger for initiating collection of one or more CMCD metrics.

At 630, the AF may transmit, to a device via session handling interface, service access information indicative of at least one of: the CMCD reporting scheme and the reporting type. In an example, the AF may determine a reporting interval for collection of the one or more CMCD metrics. The service access information may be indicative of the reporting interval. The AF may transmit, to the device, an indication (e.g., the reporting type) for receiving one or more CMCD metrics via an interface using an in-band mechanism or an out-of-band mechanism. In an example, the AF may receive, from the device, one or more CMCD metrics via the interface using the out-of-band mechanism. The AF may transmit, to the AP, the received one or more CMCD metrics.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method performed by a wireless transmit/receive unit (WTRU), the method comprising:
receiving, from an application function (AF), service access information indicative of at least one of: a common media client data (CMCD) reporting scheme and a reporting type;
collecting, based on the CMCD reporting scheme, one or more CMCD metrics associated with a media streaming session;
generating, based on the one or more CMCD metrics, at least one CMCD metric report in a reporting format indicated by the CMCD reporting scheme; and
transmitting, based on the reporting type, the at least one CMCD metric report to the AF or an application server (AS).

2. The method of claim 1, wherein the at least one CMCD metric report is transmitted to the AF via an interface using an out-of-band mechanism.

3. The method of claim 2, further comprising:
transmitting, to the AS, a media segment request comprising the at least one CMCD metric report.

4. The method of claim 3, wherein the media segment request is transmitted to the AS via an interface using an in-band mechanism.

5. The method of claim 4, wherein the reporting type is indicative of using the in-band mechanism or the out-of-band mechanism.

6. The method of claim 1, wherein the service access information is further indicative of a reporting interval for collecting the one or more CMCD metrics.

7. The method of claim 1, further comprising:
receiving a quality of experience (QoE) configuration including a trigger for collecting the one or more CMCD metrics.

8. A wireless transmit/receive unit (WTRU), comprising:
a transceiver; and
a processor, wherein the transceiver and the processor are configured to:
receive, from an application function (AF), service access information indicative of at least one of: a common media client data (CMCD) reporting scheme and a reporting type,
collect, based on the CMCD reporting scheme, one or more CMCD metrics associated with a media streaming session,
generate, based on the one or more CMCD metrics, at least one CMCD metric report in a reporting format indicated by the CMCD reporting scheme, and
transmit, based on the reporting type, the at least one CMCD metric report to the AF or an application server (AS).

9. The WTRU of claim 8, wherein the at least one CMCD metric report is transmitted to the AF via an interface using an out-of-band mechanism.

10. The WTRU of claim 9, wherein the transceiver and the processor are further configured to:
transmit, to the AS, a media segment request comprising the at least one CMCD metric report.

11. The WTRU of claim 10, wherein the media segment request is transmitted to the AS via an interface using an in-band mechanism.

12. The WTRU of claim 11, wherein the reporting type is indicative of using the in-band mechanism or the out-of-band mechanism.

13. The WTRU of claim 8, wherein the service access information is further indicative of a reporting interval for collecting the one or more CMCD metrics.

14. The WTRU of claim 8, wherein the transceiver and the processor are further configured to:
receive a quality of experience (QoE) configuration including a trigger for collecting the one or more CMCD metrics.

15. A method performed by an application function (AF), the method comprising:
establishing a provisioning session with an application provider (AP) via a provisioning interface;
receiving, from the AP during the provisioning session, provisioning configuration indicative of a common media client data (CMCD) reporting scheme and a reporting type; and
transmitting, to a device via session handling interface, service access information indicative of at least one of: the CMCD reporting scheme and the reporting type.

16. The method of claim 15, further comprising:
determining a reporting interval for collection of one or more CMCD metrics, wherein the service access information is indicative of the reporting interval.

17. The method of claim 15, further comprising:
receiving, from the AP, a quality of experience (QoE) configuration including a trigger for initiating collection of one or more CMCD metrics.

18. The method of claim 15, further comprising:
transmitting, to the device, an indication for transmitting one or more CMCD metrics via an interface using an in-band mechanism or an out-of-band mechanism.

19. The method of claim 15, further comprising:
receiving, from the device, one or more CMCD metrics via an interface using an out-of-band mechanism.

20. The method of claim 19, further comprising:
transmitting, to the AP, the one or more CMCD metrics.
